(19) United States
(12) Patent Application Publication
(10) Pub. No.: US 2011/0299804 A1
(43) Pub. Date: Dec. 8, 2011

(54) ROLLER BEARING FOR UNDERWATER APPLICATIONS

(75) Inventors: Eduard Beresch, Sulzheim (DE); Heinz-Dieter Schwerdtfeger, Bad Kohlgrub (DE)

(73) Assignee: SCHAEFFLER TECHNOLOGIES GMBH & CO. KG, Herzogenaurach (DE)

(21) Appl. No.: 12/999,701

(22) PCT Filed: Jun. 10, 2009
(86) PCT No.: PCT/DE09/00814

§ 371 Date: Jul. 19, 2011

(30) Foreign Application Priority Data
Jun. 20, 2008 (DE) 10 2008 029 483.7

(51) Int. Cl. F16C 33/62; F16C 33/32

(52) U.S. Cl. 384/492

(57) ABSTRACT

A roller bearing for underwater applications, in particular for underwater turbines, which has an outer ring and an inner ring arranged in a bearing housing made from a stainless material. Several roller bodies are held in a cage and are arranged between the bearing rings on corresponding roller tracks made from a corrosion-resistant material. In order to save weight for a roller bearing, the diameter of which is, in particular between 0.2 and 10 m, at least one of the bearing rings is designed as bearing ring for a thin ring bearing.

### FIELD OF THE INVENTION

The application relates to a rolling bearing for underwater applications, which rolling bearing is used in particular in underwater turbines for power generation.

### BACKGROUND OF THE INVENTION

Rolling bearings of said type are directly exposed to the surrounding medium, that is to say the water, wherein aggressive sea water leads to corrosion. Against this background, such rolling bearings are formed from corrosion-resistant materials, such as for example from ceramic materials or from special steels. Bearings for underwater turbines have a diameter typically of between 1 m and 10 m. This additionally makes it difficult to service the bearing and to exchange the bearing if it is no longer operational, for example on account of corrosion.

### Object of the Invention

The invention is based on the object of specifying an improved rolling bearing for underwater applications.

### Achievement of the Object

The object is achieved according to the invention by means of a rolling bearing for underwater applications, comprising an outer ring and an inner ring which are arranged in a bearing housing and which are composed of a rust-proof material, with a plurality of rolling bodies which are held in a cage and which are composed of a corrosion-resistant material being arranged between the bearing rings on associated raceways, and with at least one of the bearing rings being designed as a bearing ring of a thin-ring bearing.

Here, a thin-ring bearing is to be understood to mean a rolling bearing whose bearing rings have a thickness which is several times smaller than the outer diameter of the bearing, and in particular amounts to less than 1/10 of the outer diameter of the bearing. The rust-proof material may for example be a rust-proof steel, a ceramic material or a coated steel.

e invention is based on the consideration that, during the production of a rolling bearing whose diameter lies preferably in the range of ≧0.2 m, in particular in the range between 1 and 10 m, it is possible to save weight if at least one of the two bearing rings is designed as a bearing ring of a thin-ring bearing. Such rolling bearings for underwater applications are used not only in underwater turbines but rather also in shipbuilding and for hydraulic steelwork. Thin-ring bearings are generally characterized by a low mass, a low torque and a spatially compact construction, and have high strength and running accuracy. Rolling bearings whose at least one bearing ring is designed as a bearing ring of a thin-ring bearing constitute a weight-saving and material-saving design which is particularly suitable specifically for underwater applications, in which repair or an exchange is particularly difficult on account of the size of the bearing and the surrounding conditions.

The bearing ring is preferably formed so as to be thinner only in the region of the raceway. To the sides of the raceway, the bearing ring has a thickness which is several times greater than the thickness in the region of the raceway. Such a bearing can be produced particularly easily by virtue of material being removed only in the region of the raceway, with the material removal remaining low in relation to a situation in which the bearing ring is supposed to be thinned over its entire axial extent. During the production of the bearing, it is possible to start from a pipe section in which the raceway of the bearing is formed by means of a cutting process.

To save additional weight, in a preferred refinement, both bearing rings are formed as bearing rings of a thin-ring bearing.

In a preferred variant, the bearing ring which is designed as a bearing ring of a thin-ring bearing has a thickness which is in a ratio of ≦0.05 to the bearing diameter. For a diameter of the rolling bearing of up to 5 meters, the thickness of the bearing ring which is designed as a bearing ring of a thin-ring bearing is less than 25 cm, as a result of which the weight of the bearing is considerably reduced.

With regard to a particularly corrosion-resistant composition of the rolling bodies, these are preferably formed from a rust-proof iron-chromium-molybdenum steel or from a ceramic material. Such an iron-chromium-molybdenum steel, preferably with the material number 1.4108, is known under the trade name Chronidor and is characterized by very good corrosion resistance. As a ceramic material for forming the rolling bodies, it is possible for example to use an Si₃Ni₄ ceramic material.

The corrosion resistance of the rolling body is increased if, according to one preferred variant, the bearing rings are also formed from a rust-proof iron-chromium-molybdenum steel, preferably with the material number 1.4108. By means of a certain surface characteristic both of the raceways and also of the rolling bodies, advantageous rolling properties are created here in order to minimize friction during operation.

According to a further preferred embodiment, the cage is formed from plastic or is coated with Teflon or plastic. Polyether ether ketone (PEEK), for example, may be provided to form the cage.

On account of the field of application of the rolling bearing, the use of liquid lubricants, such as for example grease or oil, is not expedient. To eliminate this problem, the use of solid lubricant layers is provided here. Such solid lubricant layers may be composed for example of PTFE coatings, molybdenum sulfide coatings or graphite coatings.

In a preferred variant, the bearing housing is coated with Teflon. Furthermore, a gap of for example 0.2 mm is preferably provided between the outer ring and the bearing housing. In particular, such a gap is also formed between the inner ring and a shaft for mounting the thin-ring bearing. As a result of the coating of the bearing housing or bearing receptacle in combination with the gap, a sliding fit is formed such that the bearing remains movable to a very small extent in the bearing receptacle. As a result of said construction, the bearing should in particular not become jammed or seized as a result of corrosion. For this purpose, the thin coating of the bearing receptacle is provided with for example Teflon.

In a further preferred embodiment, openings for enabling water to flow around the bearing parts are formed in the bearing housing. The surrounding medium water, which has a viscosity of 1 cSt, can be regarded here as coolant and is therefore conducted to the movable bearing parts as a result of the special design of the bearing housing.

### BRIEF DESCRIPTION OF THE DRAWING

An exemplary embodiment of the invention is explained in more detail on the basis of a drawing, in which the single FIGURE shows a section through one half of a rolling bearing.

### DETAILED DESCRIPTION OF THE DRAWING

The FIGURE illustrates a rolling bearing 2 which is used for example in underwater turbines. The bearing 2 comprises an outer ring 4 and an inner ring 6 which are arranged in a bearing housing 8, of which only a small portion is visible. The bearing rings 4, 6 have raceways 10 on which roll a plurality of rolling bodies 14 which are held in a cage 12 and which are arranged one behind the other in the circumferential direction. During operation of the bearing, the spherical rolling bodies 14 roll about a rotational axis A of the bearing 2. Both the bearing rings 4, 6 and also the rolling bodies 14 are formed from a corrosion-resistant material such as for example a rust-proof iron-chromium-molybdenum steel or from a ceramic material. In this exemplary embodiment, the cage 12 is formed from polyether ether ketone (PEEK).

On account of the field of use of the rolling bearing 2, the bearing housing is provided with openings (not illustrated in any more detail), such that water, which acts as cooling medium, flows around the other bearing parts. Furthermore, the bearing housing 8 is coated in the direction of the outer ring 4 with a sliding layer, and a gap 16 which is merely indicated in the drawing is provided between the bearing housing 8 and the outer ring 4, such that the bearing 2 remains comparatively movable in the bearing housing 8 and cannot become jammed as a result of corrosion.

In this exemplary embodiment, the rolling bearing 2 has a diameter D of approximately 3 m. The rolling bearing 2 is designed as a thin-ring bearing, that is to say both its outer ring 4 and its inner ring 6 have a thickness d which is several times smaller than the diameter D of the bearing 2. The thickness d of the bearing rings 4,6 is in particular smaller than 15 cm, that is to say said thickness d is in a ratio of <0.05 to the diameter D.

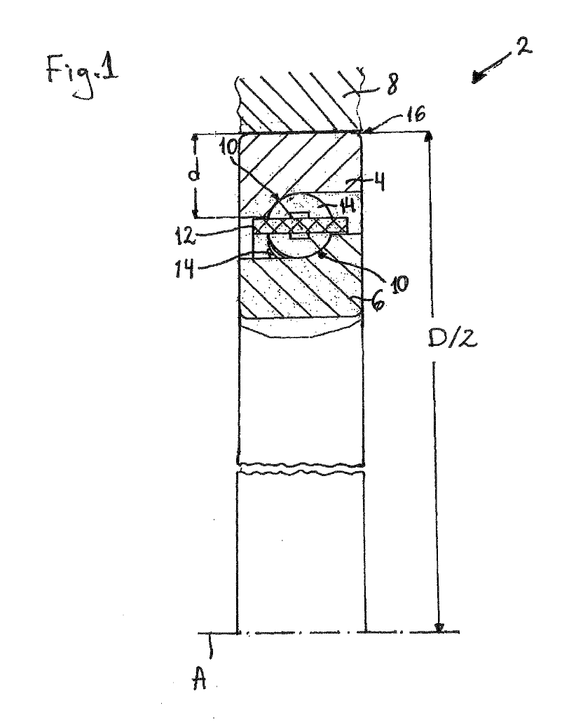

As an alternative to the embodiment shown in FIG. 1, it is possible for the rolling bearing 2 to be designed such that only one of the bearing rings 4, 6 is designed as a bearing ring of a thin-ring bearing, and in particular satisfies the above-specified ratio.

### LIST OF REFERENCE SYMBOLS

2 Rolling bearing
4 Outer ring
6 Inner ring
10 Raceway
12 Cage
14 Rolling body
16 Gap
A Rotational axis
D Bearing diameter
d Bearing ring thickness

1. A rolling bearing for underwater applications, comprising:
an outer ring and an inner ring which are arranged in a bearing housing and which are composed of a rust-proof material, with a plurality of rolling bodies which are held in a cage and which are composed of a corrosion-resistant material being arranged between the bearing rings on associated raceways,
wherein at least one of the bearing rings is designed as a bearing ring of a thin-ring bearing.

2. The rolling bearing as claimed in claim 1, wherein the at least one of the bearing rings which is designed as the bearing ring of the thin-ring bearing is formed so as to be thinner only in a region of the raceway.

3. The rolling bearing as claimed in claim 1, wherein both of the bearing rings are designed as bearing rings of the thin-ring bearing.

4. The rolling bearing as claimed in claim 1, wherein a bearing diameter>1 m.

5. The rolling bearing as claimed in claim 4, wherein the bearing ring which is designed as the bearing ring of the thin-ring bearing has a thickness which is in a ratio of ≦0.05 to the bearing diameter.

6. The rolling bearing as claimed in claim 1, wherein the rolling bodies are formed from a rust-proof iron-chromium-molybdenum steel or from a ceramic material.

7. The rolling bearing as claimed in claim 1, wherein the bearing rings are formed from a rust-proof iron-chromium-molybdenum steel.

8. The rolling bearing as claimed in claim 1, wherein the cage is formed from plastic or is coated with Teflon or plastic.

9. The rolling bearing as claimed in claim 1, wherein the rolling bodies are coated with a solid lubricant layer.

10. The rolling bearing as claimed in claim 1, wherein a bearing housing is coated with Teflon.

11. The rolling bearing as claimed in claim 10, wherein a gap is provided between the outer ring and the bearing housing.

12. The rolling bearing as claimed in claim 1, wherein openings for enabling water to flow around the bearing parts are formed in the bearing housing.

13. The use of a rolling bearing as claimed in claim 1 for underwater applications.

14. The rolling bearing as claimed in claim 1, wherein a bearing diameter is in a range between 1 m and 5 m.
